(19) United States
(12) Patent Application Publication
(10) Pub. No.: US 2026/0248675 A1
(43) Pub. Date: Aug. 27, 2026

(54) MODULAR PHYSIOTHERAPY AND REHABILITATION DEVICE

(71) Applicants: Ramakrishna Reddy KATUKURI, Kerala (IN); Amar Nath HARIKUMAR, Kerala (IN); Jubin MATHEW, Kerala (IN)

(72) Inventors: Ramakrishna Reddy KATUKURI, Kerala (IN); Amar Nath HARIKUMAR, Kerala (IN); Jubin MATHEW, Kerala (IN)

(21) Appl. No.: 18/877,503

(22) PCT Filed: Jun. 23, 2023
(86) PCT No.: PCT/IB2023/056507

§ 371 Date: Dec. 20, 2024

(30) Foreign Application Priority Data
Jun. 22, 2022 (IN) 202241035858

(51) Int. Cl. A61H 1/02

(52) U.S. Cl. CPC A61H 1/02; A61H 2201/0107; A61H 2201/0192; A61H 2201/1602; A61H 2201/1676; A61H 2201/5007; A61H 2201/5043

(57) ABSTRACT

The present disclosure relates to a modular physiotherapy and rehabilitation device (100) including one or more actuators (102), one or more links (104) coupled to one or more actuators (102) to provide support between one or more actuators (102), one or more actuators (102) and one or more links (104) are mounted on an adjustable stand (106) to support weight of one or more actuators (104) and one or more links (104) attached to a patient, a central controller system (108) connected to one or more actuators (102) and one or more links (104) to processes information received from one or more actuators (102), one or more links (104) and a user controller unit (110) connected to central controller system (108) to give commands pertaining to requirements of treatment and to view the processed data from sensors, and a display unit (112) connected to central controller system (108) to run one or more games for providing engagement and participation during the treatment.

### TECHNICAL FIELD

The present disclosure relates generally to the field of medical devices. In particular, the present disclosure more specifically pertains to a modular physiotherapy and rehabilitation device that assists with physiotherapy and fast rehabilitation of patients.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

Rehabilitation is an essential aspect of recovery for individuals suffering from physical impairments. It helps improve mobility, restore function, and enhance overall quality of life. However, conventional physiotherapy methods face several challenges that can hinder the recovery process. These challenges include the need for frequent patient assessments, which can increase therapy time and strain for both the patient and the therapist. Additionally, conventional therapy can lead to physical strain and fatigue for therapists during the therapy, reducing their ability to provide effective care. Poor patient engagement is another challenge, which can reduce the effectiveness of therapy and hinder recovery.

At different stages of injury and recovery, a patient's rehabilitative demands may alter, necessitating the use of different treatment systems and procedures at different periods. Throughout the rehabilitation process, a patient may require a variety of therapy and assistance strategies. Rehabilitation may be required for a variety of joints, either sequentially or concurrently. Typically, a clinic, hospital, and/or clinician will have multiple patients with diverse and changing needs over time, such as different joints and limbs, as well as varying sizes.

In light of these challenges, there has been a growing interest in the development of robotic rehabilitation technology. Robotic rehabilitation devices are designed to provide personalized therapy sessions to patients and can be tailored to their individual needs. These devices offer several benefits over conventional therapy methods, including real-time feedback and progress tracking, increased patient engagement, and reduced strain on therapists. Despite these benefits, there are several drawbacks and problems that exist with the systems and methods of rehabilitation.

Existing inventions in the field of rehabilitation lack modularity, portability, and the ability to treat different types of disabilities. The current devices are either bulky, expensive or can only treat specific types of disabilities. Current systems in rehabilitation include gait training devices that are used to provide repetitive gaiting training to patients who are paralyzed in the lower body. These devices are bulky and expensive and cannot be used to provide joint-level therapy.

Other systems include upper limb rehabilitation devices such as Armeo Power or the prior art CN111700775A or U.S. Pat. No. 7,862,524B2. These devices are used only to treat patients who require rehabilitation in the upper body. Other devices include Cyberdyne HAL or prior art U.S. Pat. No. 7,190,141B1, which are lower-body exoskeletons that are used to treat patients with lower-body disabilities. The problems with these devices are they can treat only specific types of disabilities and thus leads to a lack of utilization of the product.

There is, therefore, a need to overcome the above drawbacks, limitations, and shortcomings associated with the existing inventions, and provide a simple and easily operable solution which can assist the patients during physiotherapy and rehabilitation.

### OBJECTS OF THE INVENTION

Some of the objects of the present disclosure, which at least one embodiment herein satisfies are as listed herein below.

An object of the present disclosure is to provide a simple and easily operable modular physiotherapy and rehabilitation device that assists with physiotherapy and fast rehabilitation of patients.

Another object of the present disclosure is to provide a device with actuators which is a powered rotary element with in-built sensors connected to one or more links for assisting and measuring the parameters of a human joint.

Another object of the present disclosure is to provide a device with length adjustable links with in-built sensors which can be connected to one or more actuators using a tool-less connector or connectors.

Another object of the present disclosure is to provide a device that utilizes an adjustable stand to provide support to the weight of the device attached to a patient.

Another object of the present disclosure is to provide a device with a central controller system to communicate with the user controller unit and input commands for computing a motion to one or more actuators and links.

Another object of the present disclosure is to provide a device that utilizes a user controller unit to give commands pertaining to the requirements of the treatment of a patient and view data from various sensors.

Another object of the present disclosure is to provide a device that utilizes a display unit to run games for providing engagement of the patient during treatment.

### SUMMARY

Aspects of the present disclosure relate to medical devices. In particular, the present disclosure pertains to a modular physiotherapy and rehabilitation device that assists with physiotherapy and fast rehabilitation of patients.

In an aspect, the disclosed modular physiotherapy and rehabilitation device can include one or more actuators, one or more links coupled to the one or more actuators to provide support between the one or more actuators, an adjustable stand coupled to the one or more actuators and the one or more links to provide support to the weight of the one or more actuators and the one or more links attached to a patient, a central controller system connected to the one or more actuators and the one or more links to process information received from the one or more actuators and the one or more links, a user controller unit connected to the central controller system to give commands pertaining to the requirements of the treatment of a patient and can be used to view the processed data from sensors and a display unit connected to the central controller system to run games for providing engagement of the patient during treatment.

The one or more actuators can be a powered rotary element with one or more sensors connected to the one or more links to assist and measure the parameters of a human joint and can include a motion controller board with an embedded processor to sense information and input one or more commands to compute a required motion.

The one or more links can be length adjustable and can include one or more sensors to measure the parameters of a human joint. The one or more links can include on-board processor with an interface 146 to set the limb type of the link.

In addition, the adjustable stand can include one or more connectors to mount the one or more actuators and the one or more links to the adjustable stand. The one or more links can be attached to a patient through one or more straps and can include a mechanism to adjust the length of the one or more links.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in, and constitute a part of this specification. The drawings illustrate exemplary embodiments of the present disclosure, and together with the description, serve to explain the principles of the present disclosure.

FIG. 1 illustrates an exemplary isometric view of the proposed modular physiotherapy and rehabilitation device, in accordance with an embodiment of the present disclosure.

FIGS. 2A & 2B illustrate an isometric view of an actuator and a sectional view of an actuator of the modular physiotherapy and rehabilitation device, in accordance with an embodiment of the present disclosure.

FIGS. 3A & 3B illustrate an enlarged front and sectional view of one or more links of the modular physiotherapy and rehabilitation device, in accordance with an embodiment of the present disclosure.

FIGS. 4A-4C illustrate types of one or more links of the modular physiotherapy and rehabilitation device, in accordance with an embodiment of the present disclosure.

FIGS. 5A & 5B illustrate an isometric view and front view of an adjustable stand of the modular physiotherapy and rehabilitation device, in accordance with an embodiment of the present disclosure.

FIGS. 6A-6C and 7A-7B illustrate a front view of an adjustable stand with a rotating platform and actuators of the modular physiotherapy and rehabilitation device, in accordance with an embodiment of the present disclosure.

FIG. 8 illustrates an exemplary block diagram of the connections between the components of the modular physiotherapy and rehabilitation device, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments. On the contrary, the intention is to cover all modifications, equivalents, and alternatives falling within the spirit, and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details. Embodiments of this disclosure relate to medical devices. In particular, the present disclosure pertains to a modular physiotherapy and rehabilitation device that assists with physiotherapy and fast rehabilitation of patients.

In an aspect, the disclosed modular physiotherapy and rehabilitation device can include one or more actuators, one or more links coupled to the one or more actuators to provide support between the one or more actuators, an adjustable stand coupled to the one or more actuators and the one or more links to provide support to the weight of the one or more actuators and the one or more links attached to a patient, a central controller system connected to the one or more actuators and the one or more links to process information received from the one or more actuators and the one or more links, a user controller unit connected to the central controller system to give commands pertaining to the requirements of the treatment of a patient and can be used to view the processed data from sensors and a display unit connected to the central controller system to run games for providing engagement of the patient during treatment.

It is to be appreciated that while various embodiments have been explained herein with reference to a modular physiotherapy and rehabilitation device, the concept of the present disclosure can also be used for other medical devices for physiotherapy treatment, and all such applications are well within the scope of the present disclosure without any limitations whatsoever.

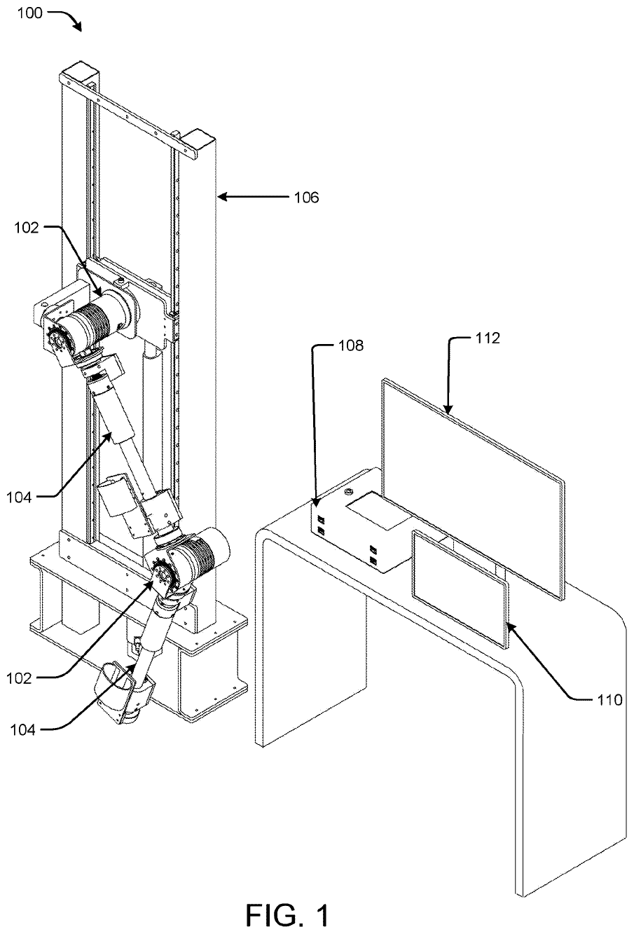

Referring to FIG. 1, in an embodiment, the disclosed modular physiotherapy and rehabilitation device 100 (hereinafter, also referred to as device 100) is shown. The device 100 can include one or more actuators 102, one or more links 104 coupled to the one or more actuators 102 to provide support between the one or more actuators 102, an adjustable stand 106 coupled to the one or more actuators 102 and the one or more links 104 and the one or more actuators 102 and the one or more links 104 can be mounted on the adjustable stand 106 for providing support to the weight of the one or more actuators 102 and the one or more links 104 attached to a patient, a central controller system 108 can be connected to the one or more actuators 102 and the one or more links 104, and a display unit 112 can be connected to the central controller system 108 to run one or more games for providing engagement and participation during treatment of the patient.

In addition, the central controller system 108 can process the information received from the one or more actuators 102, the one or more links 104 and the user controller unit 110. The user controller unit 110 can give commands pertaining to the requirements of the treatment of the patient and view data from various sensors.

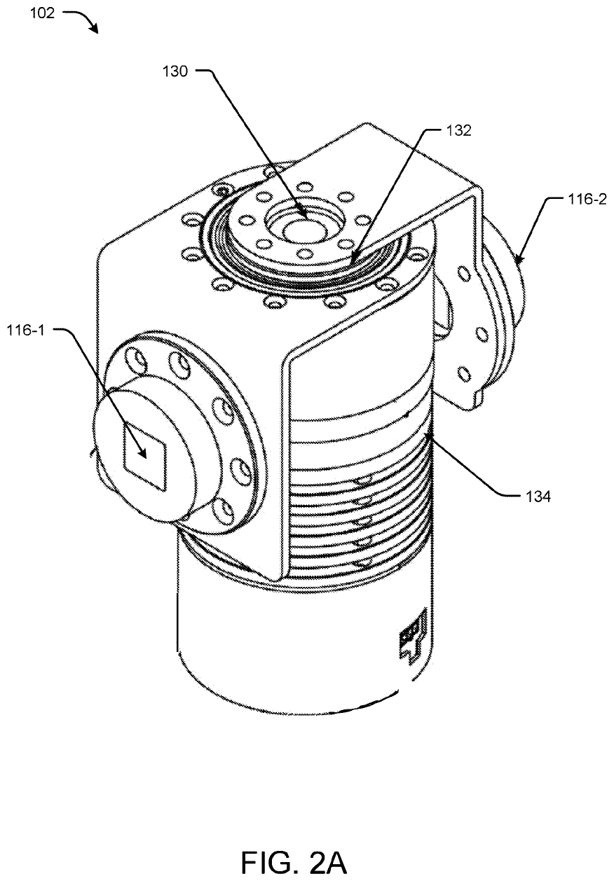

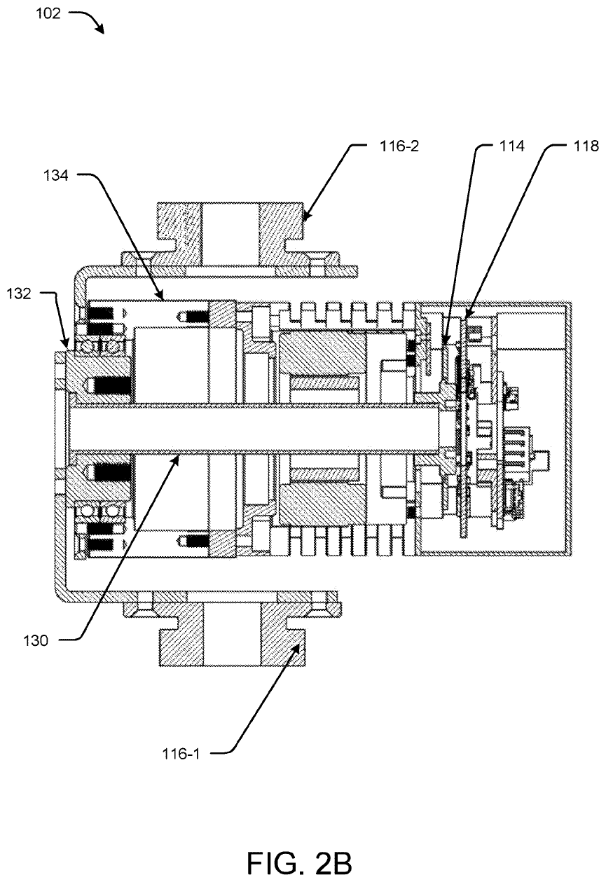

Referring to FIGS. 2A & 2B where an isometric view of an actuator and a sectional view of an actuator of the modular physiotherapy and rehabilitation device is shown. The one or more actuators 102 (hereinafter, also referred to as actuator 102) can be a powered rotary element with one or more sensors 114 connected to the one or more links 104 to assist and measure the parameters of a human joint. The actuator 102 can include one or more connector points 116-1, 116-2 with one of them fixed on a rotary part 132 and another one fixed on a static part 134 of the actuator 102. The actuator 102 can include a motion controller board 118 with an embedded processor to use information from the one or more sensors 114 and input commands to compute a required motion. The actuator can include a hollow shaft 130 to allow passage of wires with minimum twist when the actuator is in rotation.

In addition, the one or more sensors 114 can include a rotary position sensor to measure the rotary position of the actuator 102, an orientation sensor to measure the orientation of the actuator to the ground, a torque sensor to measure the torque acting between the rotary part 132 and the static part 134 and a muscle activity sensor to measure the amount of activity in the muscles of the human limb. The orientation sensor can be incorporated with the motion controller board 118 and the muscle activity sensor can be externally connected to the body of the patient and the motion controller board 118. The torque sensor can be a strain gauge mounted on any part of the actuator 102 to detect the flexure of the part as external torque acts on it.

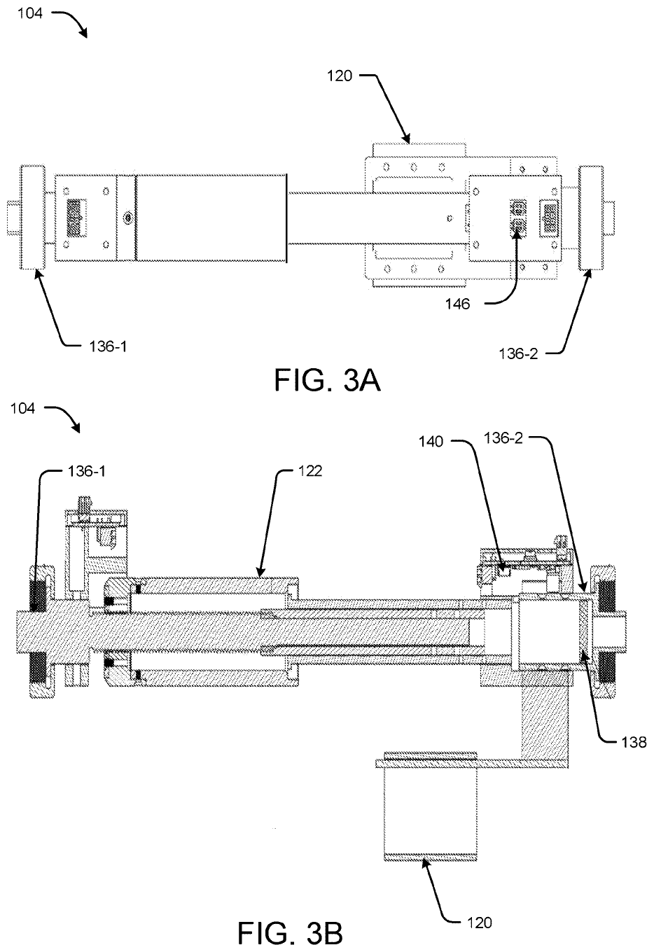

Referring to FIGS. 3A & 3B where an enlarged front and sectional view of one or more links of the modular physiotherapy and rehabilitation device is shown. The one or more links 104 (hereinafter, also referred to as link 104 can include one or more straps 120 to attach to the limb of the patient. The link 104 can include a mechanism 122 to adjust the length of the link 104 and can be equipped with one or more sensors 138. The link 104 can also include an onboard processor board 140 to relay information collected by the one or more sensors 138. The link 104 can include an interface 146 to set which limb the link 104 can be attached. The link 104 can include one or more connector points 136-1, 136-2 on each end of the link 104 to connect the link 104 to the actuator 102 and adjustable stand 106.

Additionally, the one or more sensors 138 can include a length measurement sensor to measure the length of the link 104, an orientation sensor to measure the orientation of the link 104 to the ground, a torque sensor to measure the torque acting on the link 104 from external sources and a muscle activity sensor to measure the amount of activity in the muscles of the human limb. The orientation sensor can be integrated into the onboard processor board 140 and the muscle activity sensor can be externally connected to the body of the patient and the onboard processor board 140. The torque sensor can be a strain gauge mounted on any part of the link 104 to detect the flexure of the part as external torque acts on it.

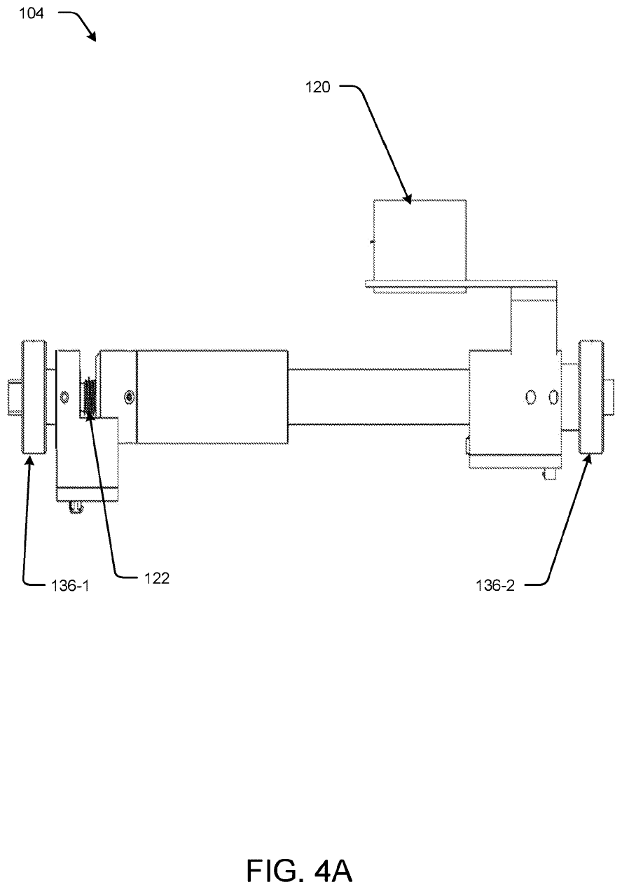

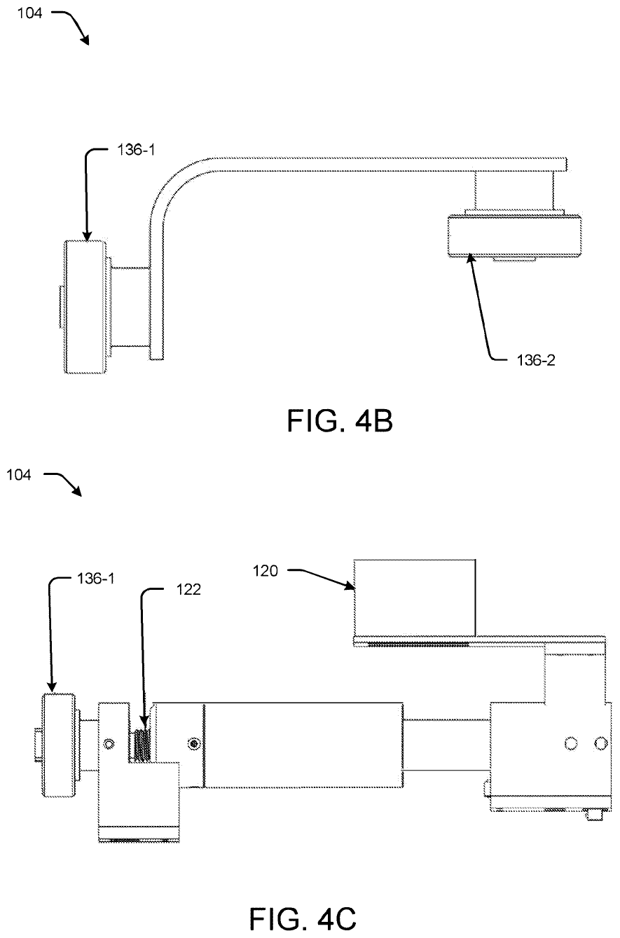

Referring to FIGS. 4A, 4B & 4C where types of one or more links of the modular physiotherapy and rehabilitation device is shown. The link 104 with the connector points 136-1, 136-2 on both ends of one or more straps 120, the link 104 with the connector points 136-1, 136-2 on both ends of the link 104 without the one or more straps 120 and link 104 with the connector point 136-1 on one end with a strap 120.

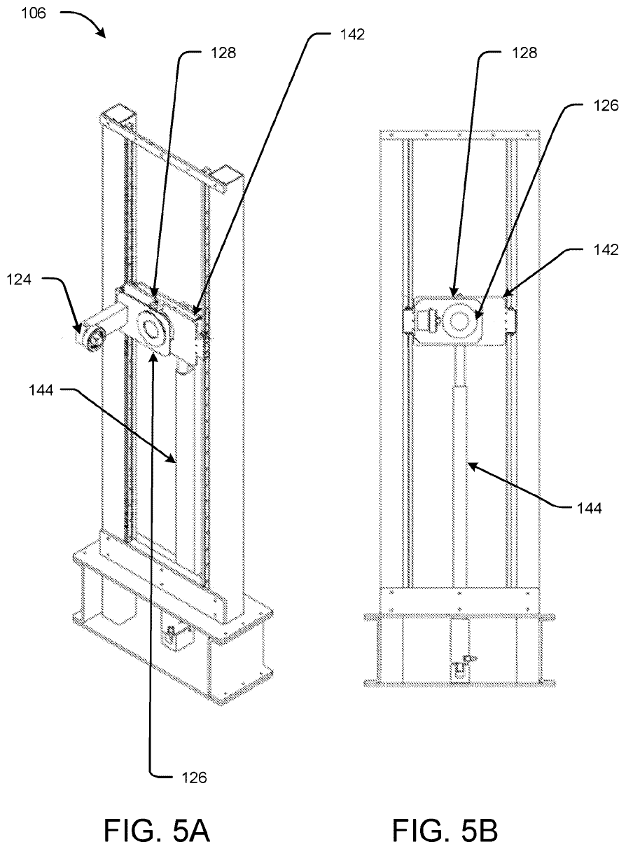

Referring to FIGS. 5A & 5B where an isometric view and front view of an adjustable stand of the modular physiotherapy and rehabilitation device is shown. The adjustable stand 106 can include one or more connectors 124 to mount the actuators 102 and link 104 to the adjustable stand 106. The one or more connectors 124 can be mounted on a rotating platform 126 to provide different orientations to mount the actuators 102 and link 104. The rotating platform 126 can be locked into place using a Key 128 that on turning can press down on to the rotating platform 126 to arrest its motion. The rotating platform 126 can be mounted onto a linearly moving platform 142 that moves up and down to provide a required height for the mount. A height adjustment mechanism 144 can be provided to move the platform 142 by electrical or manual operation.

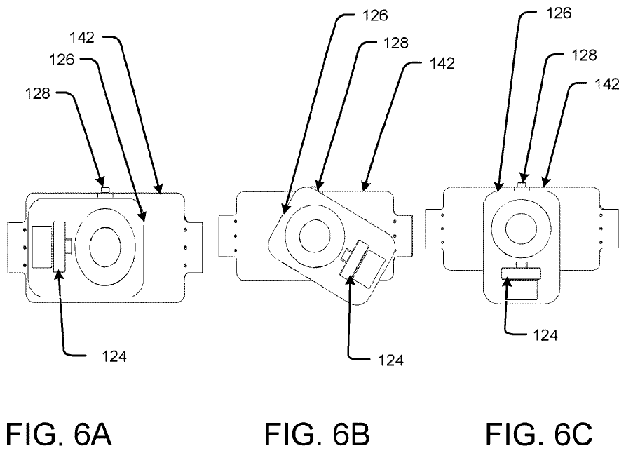

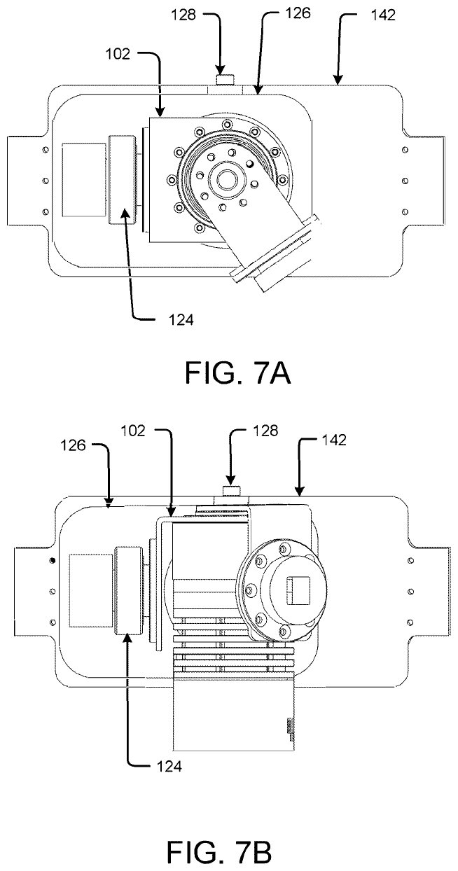

Referring to FIGS. 6A-6C & 7A-7B where a front view of an adjustable stand with a rotating platform and front view of the adjustable stand with actuators of the modular physiotherapy and rehabilitation device is shown. The one or more connectors 124 of the adjustable stand 106 mounted on the rotating platform 126 to provide different orientations to mount the actuators 102 and the link 104. The different orientations can be used to accommodate the various positions for the treatment of the patient. The actuators 102 and the link 104 can be attached in different orientations to the one or more connectors 124 to provide motion in different planes. The rotating platform 126 can be locked into place using a Key 128 that on turning can press down on to the rotating platform 126 to arrest its motion. The rotating platform 126 can be mounted onto a linearly moving platform 142 that moves up and down to provide a required height for the mount.

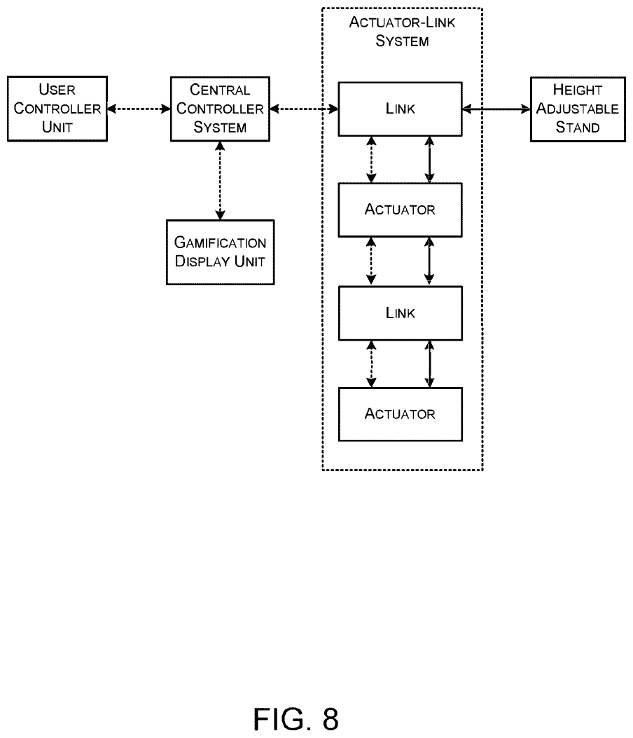

Referring to FIG. 8 an exemplary block diagram of the connections between the components of the modular physiotherapy and rehabilitation device is shown. The one or more actuators 102 and one or more links 104 can be coupled with each other to provide support between the one or more actuators 102 and the adjustable stand 106 can be coupled to the one or more actuators 102 and the one or more links 104 to provide support to the weight of the one or more actuators 102 and the one or more links 104. The central controller system 108 can be connected to the one or more actuators 102 and the one or more links 104 to process information received from the one or more actuators 102 and the one or more links 104, a user controller unit 110 can be connected to the central controller system 108 to give commands pertaining to the requirements of the treatment of a patient and to show processed data from sensors and a display unit 112 can be connected to the central controller system 108 to run games for providing engagement of the patient during treatment.

The electrical connections (communications and power) to the onboard motion controller board 118 of the actuator 102 and the onboard processor board 140 of the link 104 can be wired or wireless or a combination of both. The link 104 and actuators 102 can be connected to the central controller system 108 through wired or wireless connection or a combination of both. The user controller unit 110 and the display unit 112 can be connected to the central controller system 108 through wired or wireless connection or a combination of both. In the exemplary block diagram the solid lines can show the mechanical connections and the dotted lines can show the electrical connections that can be communications and power which can be wired or wireless connections.

Thus, the present disclosure provides a simple and easily operable solution which can assist the patients during physiotherapy and rehabilitation.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are comprised to enable a person having ordinary skill in the art to make and use the invention when combined with information and knowledge available to those having ordinary skill in the art.

### Advantages of the Invention

The present disclosure provides a device that provides a tool-less connection between actuators, links, and the stand to allow easy attachment and reconfiguration of the device.

The present disclosure provides a device that determines which joint each actuator is attached to allowing for customized parameterization and safety limits.

The present disclosure provides a device that can be adapted to various configurations and attached to different limbs, making it suitable for use in multiple joints and accommodating patients of different heights.

The present disclosure provides a device that provides a hollow shaft design of actuators to allow wired electrical connections to be made without getting twisted, which simplifies the connection process between actuators and links in the serial chain, ensuring a hassle-free setup.

The present disclosure provides a device that provides an adjustable stand capable of supporting the weight of the actuators and links and has an adjustable height and different mounting point orientations to allow for effective utilization in various patient positions.

The present disclosure provides a device that incorporates sensors in actuators and links to provide real-time feedback on position, orientation, force/torque, muscle activity, and joint parameters.

1. A modular physiotherapy and rehabilitation device comprising:
one or more actuators;
one or more links coupled to the one or more actuators, wherein the one or more links provides support between the one or more actuators;
an adjustable stand coupled to the one or more actuators and the one or more links, wherein the one or more actuators and the one or more links are mounted on the adjustable stand for providing support to the weight of the one or more actuators and the one or more links attached to a patient;
a central controller system connected to the one or more actuators and the one or more links, wherein the central controller system processes the information received from the one or more actuators, the one or more links and a user controller unit;
a user controller unit connected to the central controller system (108) to give commands pertaining to the requirements of the treatment of a patient and to view processed data from one or more sensors; and
a display unit connected to the central controller system to run one or more games for providing engagement and participation during the treatment of the patient.

2. The device as claimed in claim 1, wherein the one or more actuators are a powered rotary element with one or more sensors connected to the one or more links to assist and measure the parameters of a human joint.

3. The device as claimed in claim 1, wherein the one or more actuators comprise one or more connector points coupled to the one or more links and the adjustable stand.

4. The device as claimed in claim 2, wherein the one or more sensors comprise a rotary position sensor, an orientation sensor, a torque sensor and a muscle activity sensor.

5. The device as claimed in claim 1, wherein the one or more actuators comprise a motion controller board with an embedded processor to sense information and input one or more commands to compute a required motion.

6. The device as claimed in claim 1, wherein the one or more links (104) is attached to a patient through one or more straps.

7. The device as claimed in claim 1, wherein the one or more links comprises an interface to set which limb the one or more link is attached to.

8. The device as claimed in claim 1, wherein the one or more links comprises a mechanism to adjust the length of the one or more links.

9. The device as claimed in claim 1, wherein the one or more links comprises a length measurement sensor, an orientation sensor, a torque sensor and a muscle activity sensor.

10. The device as claimed in claim 1, wherein the adjustable stand comprises one or more connectors to mount the one or more actuators and the one or more links to the adjustable stand.

11. The device as claimed in claim 9, wherein the one or more connectors are mounted on a rotating platform to mount the one or more actuators and the one or more links and is locked into place using a key.
